(19) United States
(12) Patent Application Publication
(10) Pub. No.: US 2017/0170974 A1
(43) Pub. Date: Jun. 15, 2017

(54) METHOD FOR CONTROLLING PATH OF CHARGING AND DATA COMMUNICATION AND ELECTRONIC DEVICE IMPLEMENTING THE SAME

(71) Applicant: Samsung Electronics Co., Ltd., Gyeonggi-do (KR)

(72) Inventors: Ba-Da KANG, Gyeonggi-do (KR); Han-Shil CHOI, Seoul (KR); Mirim KIM, Gyeonggi-do (KR); Hyun-Seok SEO, Gyeonggi-do (KR)

(21) Appl. No.: 15/274,083

(22) Filed: Sep. 23, 2016

(30) Foreign Application Priority Data
Dec. 15, 2015 (KR) 10-2015-0178953

(51) Int. Cl. H04L 12/10; H02J 7/00

(52) U.S. Cl. CPC H04L 12/10; H02J 7/0052

(57) ABSTRACT

An electronic device comprising: a first interface configured to connect to an external power supply device; a second interface configured to connect to a first external electronic device; and a control circuit operatively coupled to the first interface and the second interface, configured to: establish a first electrical path between the first interface and the second interface, when the first interface is connected to the external power supply device and the second interface is connected to the first external electronic device; disconnect the first electrical path; and provide a data signal to the first external electronic device while the first external device with power that is supplied by the external power supply device, wherein the data signal and the power are provided to the first external electronic device via the second interface.

### CLAIM OF PRIORITY

This application claims the priority under 35 U.S.C. §119(a) to Korean Application Serial No. 10-2015-0178953, which was filed in the Korean Intellectual Property Office on Dec. 15, 2015, the entire content of which is hereby incorporated by reference.

### TECHNICAL FIELD

The present disclosure relates to electronic devices in general, and more particularly to a method for controlling path of charging and data communication and electronic device implementing the same.

### BACKGROUND

Recently, with the progress of the digital technology, electronic devices, such as a mobile communication terminal, a Personal Digital Assistant (PDA), an electronic organizer, a smartphone, a tablet Personal Computer (PC), and the like, which can perform communication and can process personal information while moving, are being variously released. The electronic device has various functions, such as a voice call function, a message transmission function (e.g., a Short Message Service (SMS), a Multimedia Messaging Service (MMS), etc.), a video call function, an electronic organizer function, an image-capturing function, an email transmission/reception function, a broadcast reproduction function, an Internet function, a music reproduction function, a schedule management function, a Social Network Service (SNS) function, a messenger function, a dictionary function, a game function, and the like.

The electronic device uses a battery for portability. The battery of the electronic device needs to be charged, and battery charging methods may currently be classified into wired charging and wireless charging. Moreover, as the usage of the battery according to usability increases, the electronic device requires a fast charging function of quickly charging the battery.

When the electronic device is connected to a fast charger (e.g., an Adaptive Fast Charging Travel Adapter (AFC TA)), the electronic device starts BC1.2 communication with the fast charger through a Vbus line. When the BC1.2 communication is completed, the electronic device applies a voltage of +0.6 V to a D+ line, through which the electronic device is connected to the fast charger, and transmits/receives whether AFC is supported and a supportable power list while communicating with the fast charger through a D− line. When the fast charger is not supplied with the voltage of +0.6 V through the D+ line, or when the fast charger is disconnected from the Vbus, the fast charger does not provide fast charging. Accordingly, for the fast charging, the electronic device needs to maintain the voltage of +0.6 V on the D+ line.

In order to maintain the voltage of +0.6 V on the D+ line, the electronic device preoccupies a Universal Serial Bus (USB) line. Accordingly, the electronic device is not capable of performing USB communication during fast charging. This is because the fast charger does not provide a fast charging voltage (e.g., 9 V and 5 A) but provides a basic voltage (e.g., 5 V and 2 A) when, for a USB connection, the voltage of +0.6 V is removed from the D+ line of the electronic device and thus, the fast charging is not achieved.

### SUMMARY

According to aspects of the disclosure, an electronic device is provided comprising: a first interface configured to connect to an external power supply device; a second interface configured to connect to a first external electronic device; and a control circuit operatively coupled to the first interface and the second interface, configured to: establish a first electrical path between the first interface and the second interface, when the first interface is coupled to the external power supply device and the second interface is coupled to the first external electronic device; disconnect the first electrical path; and provide a data signal to the first external electronic device while the first external device with power that is supplied by the external power supply device, wherein the data signal and the power are provided to the first external electronic device via the second interface.

According to aspects of the disclosure, an electronic device is provided comprising: a communication interface; a memory; and at least one processor operatively coupled to the communication interface and the memory, configured to: receive power from an external power supply device when the at least one processor is coupled to the external power supply device; and receive or transmit data to an external electronic device, via the communication interface, while the at least one processor is being supplied with power by the external power supply device.

According to aspects of the disclosure, an electronic device is provided comprising: a first electrical interface that is coupled to an external power supply device; a second electrical interface that is coupled to a first external electronic device; and a control circuit operatively coupled to the first electrical interface and the second electrical interface, configured to: establish a first electrical path between the first external electronic device and the external power supply device, when the second electrical interface is coupled to the first external electronic device; disconnect the first electrical path after an identification operation is performed by at least one of the first external electronic device and the external power supply device; and establish a second electrical path between the first external electronic device and a second external electronic device while the first external electronic device is being supplied with power by the external power supply device, wherein the first electrical path is used for executing the identification operation and the second electrical path is used to carry data between the first external electronic device and the second external electronic device.

According to aspects of the disclosure, a method is provided comprising: establishing a first electrical path between an external power supply device and a first external electronic device; disconnecting the first electrical path when an identification operation is executed by the external power supply device and the first external electronic device; and transferring data between the first external electronic device and a second external electronic device while the first external electronic device is being supplied with power by the external power supply device.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram of an example of a network environment, according to various embodiments of the present disclosure;

FIG. 2 is a block diagram of an example of an electronic device, according to various embodiments of the present disclosure;

FIG. 3 is a block diagram of an example of a program module, according to various embodiments of the present disclosure;

FIG. 4 is a diagram illustrating the operation of a docking device and external devices, according to various embodiments of the present disclosure;

FIG. 5A is a circuit diagram of an example of a docking device, according to various embodiments of the present disclosure;

FIG. 5B is a circuit diagram of an example of a docking device, according to various embodiments of the present disclosure;

FIG. 5C is a circuit diagram of an example of a docking device, according to various embodiments of the present disclosure;

FIG. 6 is a flowchart of an example of a process, according to various embodiments of the present disclosure;

FIG. 7 is a flowchart of an example of a process, according to various embodiments of the present disclosure;

FIG. 8 is a flowchart of an example of a process, according to various embodiments of the present disclosure;

FIG. 9 is a flowchart of an example of a process, according to various embodiments of the present disclosure;

FIG. 10A is a circuit diagram of an example of a docking device, according to various embodiments of the present disclosure;

FIG. 10B is a circuit diagram of an example of a docking device, according to various embodiments of the present disclosure; and

FIG. 10C is a circuit diagram of an example of a docking device, according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some instances, even the term defined in the present disclosure should not be interpreted to exclude embodiments of the present disclosure.

An electronic device according to various embodiments of the present disclosure may include at least one of, for example, a smartphone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

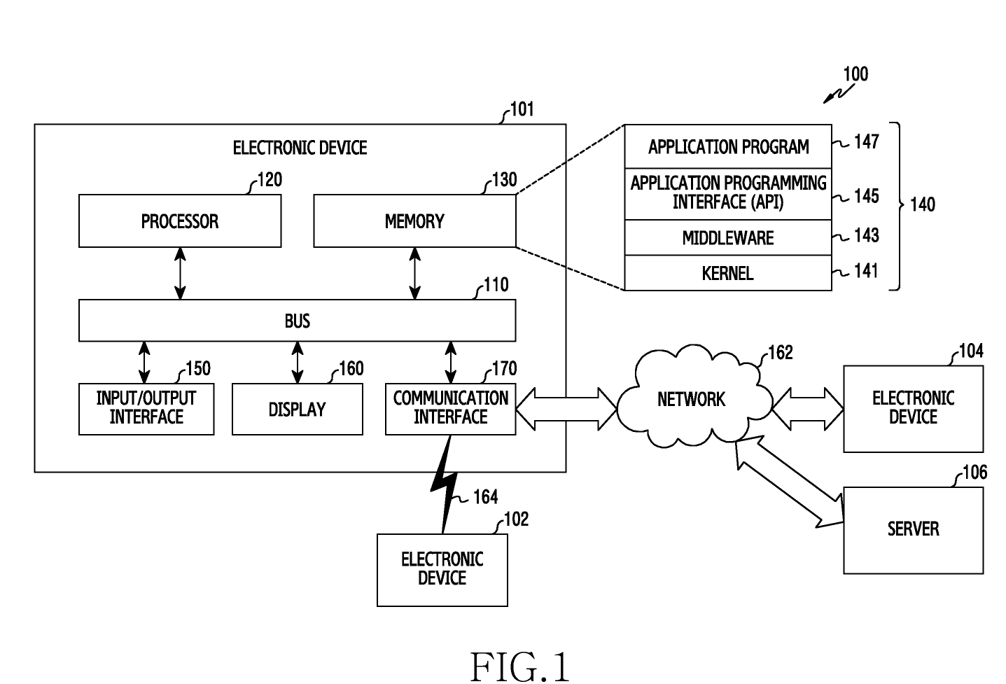

FIG. 1 is a diagram of an example of a network environment including an electronic device, according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. For example, the processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short-range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

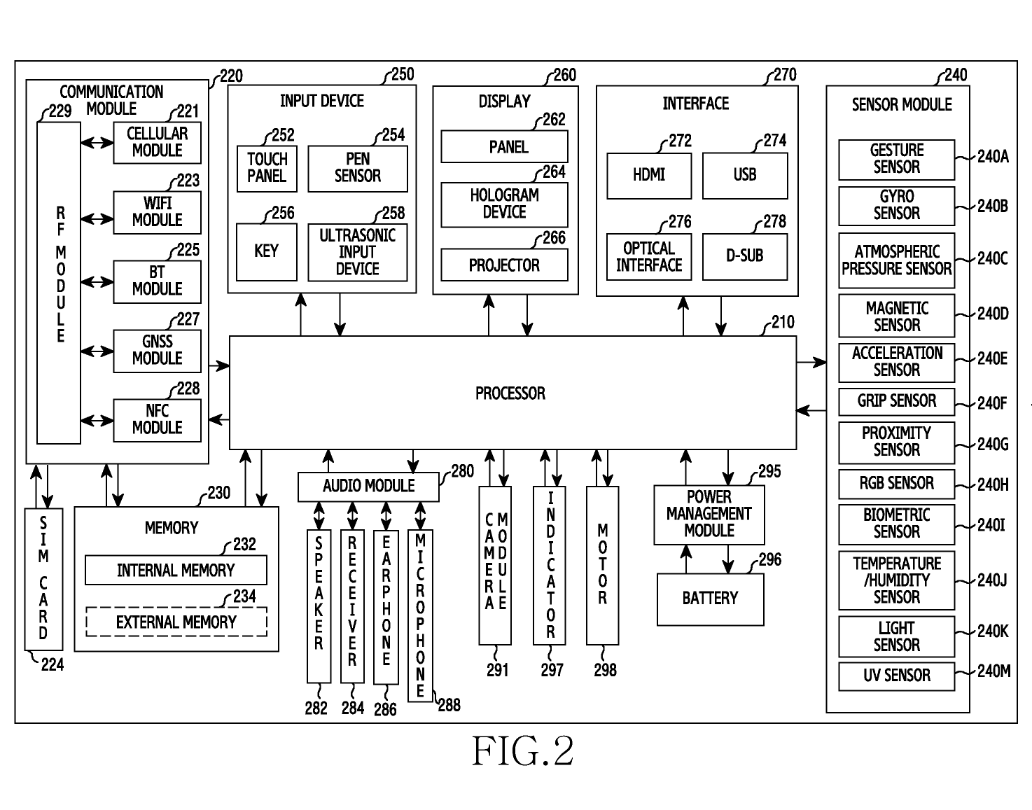

FIG. 2 is a block diagram of an example of an electronic device, according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (e.g.: SIM card) 224 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and an Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

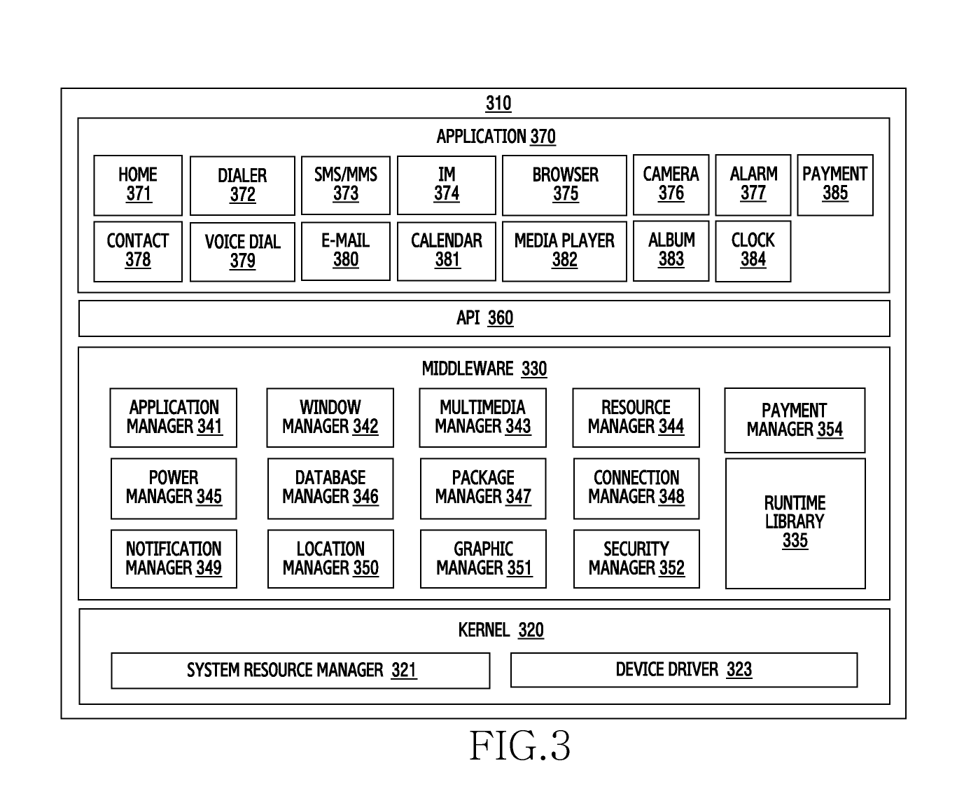

FIG. 3 is a block diagram of an example of a program module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android™, iOS™, Windows™, Symbian™, Tizen™, Bada™, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device. The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

Various embodiments of the present disclosure may provide a method and an apparatus for controlling a electrical path (or signal path) so as to enable data communication even during fast charging.

A docking device described below may be the electronic device illustrated in FIGS. 1 and 2. In this regard, the relevant electronic device will be described as a docking device in order to avoid confusion with an external electronic device (e.g., the electronic devices 102 and 104 illustrated in FIG. 1).

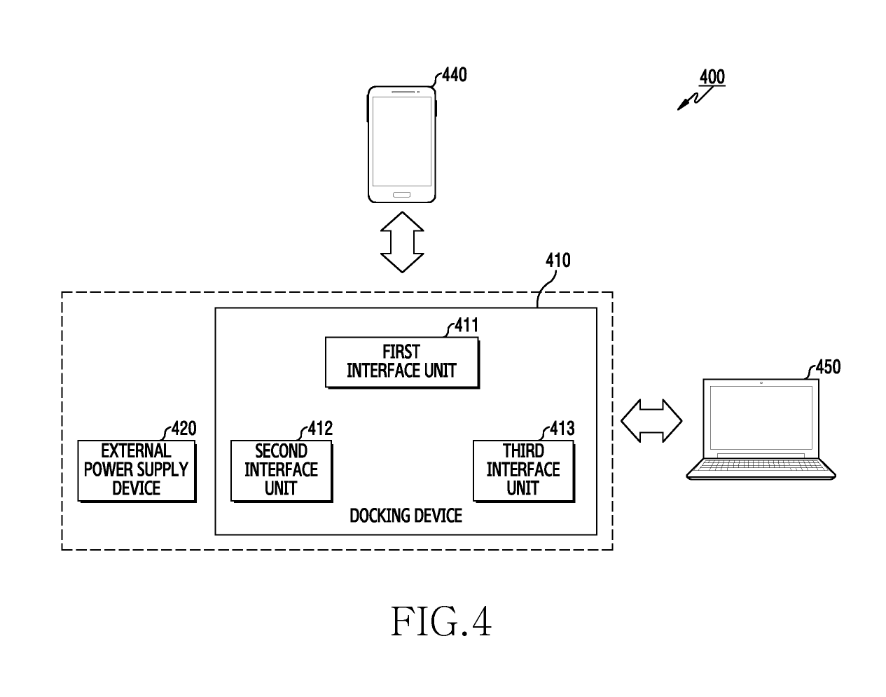

FIG. 4 is a diagram illustrating the operation of a docking device and external devices, according to various embodiments of the present disclosure. FIG. 4 illustrates a connection relation view 400 including the external devices (e.g., an external power supply device 420 (or an external voltage supply device), a first external electronic device 440, and a second external electronic device 450) connected to the docking device 410.

Referring to FIG. 4, the docking device 410 may include a first interface unit 411 (or a first electrical interface), a second interface unit 412 (or a second electrical interface), and/or a third interface unit 413 (or a third electrical interface). A USB 2.0 connector or a USB 3.0 connector may be applied to the first interface unit 411, the second interface unit 412, and/or the third interface unit 413. The first interface unit 411 may be connected to the first external electronic device 440. The second interface unit 412 may be connected to the external power supply device 420 (or an external voltage supply device). The third interface unit 413 may be connected to the second external electronic device 450.

Although not illustrated, the docking device 410 may further include a switch module or a booster circuit. The docking device 410 may detect whether the external power supply device 420, the first external electronic device 440, and the second external electronic device 450 are connected, by using a detection line (terminal or pin) of each of the first interface unit 411, the second interface unit 412, and/or the third interface unit 413.

The docking device 410 may be integrated with the external power supply device 420 into a single unit, or may be implemented separately from the external power supply device 420. The external power supply device 420 is a charger capable of performing fast charging, and may be, for example, an Adaptive Fast Charging Travel Adapter (AFC TA). A fast charger has a higher charging speed than a normal charger, and may provide a higher voltage (a large current) than the normal charger. When the external power supply device 420 is connected to the first external electronic device 440 through the docking device 410, the external power supply device 420 may provide a fast charging voltage (e.g., 9 V) to the first external electronic device 440. For example, the external power supply device 420 may provide a signal related to the fast charging voltage.

According to various embodiments of the present disclosure, when the external power supply device 420 is a fast charger, if the external power supply device 420 is connected to the first external electronic device 440, an FC PHY signal may occupy a D+ line (or a D+ pin) and a D− line (or a D− pin) of the first external electronic device 440. The external power supply device 420 may provide the fast charging voltage (e.g., 9 V) to the first external electronic device 440. However, when a connection of a Vbus line (terminal or pin) is disconnected, or when a particular voltage (e.g., 0.6 V) (e.g., a fast-charging signal) is not applied to the D+ line, the external power supply device 420 may provide the first external electronic device 440 with a normal charging voltage (e.g., 5 V) to which the fast charging voltage is reduced. To this end, the first external electronic device 440 may apply the particular voltage (e.g., a fast-charging signal) to the D+ line. When the first external electronic device 440 desires to provide data communication through the D+ line, the first external electronic device 440 may be incapable of performing data communication simultaneously with fast charging. In order to address the above-described problem, embodiments of the present disclosure enable the docking device 410 in place of the first external electronic device 440 to apply a particular voltage (e.g., a fast-charging signal) to the external power supply device 420, and thereby enable the first external electronic device 440 to perform data communication through the D+ line.

According to various embodiments of the present disclosure, when the external power supply device 420 is a normal charger, the docking device 410 may boost voltage, which is provided by the external power supply device 420, by using a booster circuit. For example, when the external power supply device 420 is connected to the docking device 410 through the second interface unit 412 and the first external electronic device 440 is connected to the first interface unit 411, the docking device 410 may boost voltage provided by the external power supply device 420, and may provide the boosted voltage to the first external electronic device 440.

The first external electronic device 440 may be the electronic device 101 illustrated in FIG. 1 or the electronic device 201 illustrated in FIG. 2. When the first external electronic device 440 is connected to the docking device 410 through the first interface unit 411, the first external electronic device 440 may be supplied with power by the external power supply device 420. Specifically, the first external electronic device 440 may be a portable terminal having a built-in battery, such as a mobile phone and a smartphone. The second external electronic device 450 may be the electronic device 101 illustrated in FIG. 1 or the electronic device 201 illustrated in FIG. 2. The second external electronic device 450 may include a terminal capable of performing data communication with the first external electronic device 440.

For example and without limitation, the first external electronic device 440 may be a smartphone, and the second external electronic device 450 may be a computer. However, the description does not limit the first external electronic device 440 to a smartphone, and does not limit the second external electronic device 450 to a computer.

When the external power supply device 420 is first connected to the first external electronic device 440, the docking device 410 may establish a first electrical path (or signal path) between the external power supply device 420 and the first external electronic device 440. For example, the first electrical path may span between the first external electronic device 440 and the external power supply device 420. When the first electrical path is established, the first external electronic device 440 and the external power supply device 420 may perform an identification information in order to identify each other. When the first external electronic device 440 identifies the connection thereof to the external power supply device 420 and the external power supply device 420 identifies the connection thereof to the first external electronic device 440, the first external electronic device 440 may be supplied with power by the external power supply device 420.

When an identification operation is completed by at least one of the first external electronic device 440 and the second external electronic device 450, the docking device 410 may change a electrical path of the external power supply device 420. For example, when the external power supply device 420 is a fast charger (e.g., an AFC TA), if the external power supply device 420 is connected to the first external electronic device 440, the external power supply device 420 may start BC1.2 communication through the Vbus line. When the BC1.2 communication is completed (e.g., when a first reference time period passes), the docking device 410 may perform a control operation for changing a electrical path of the external power supply device 420 and applying a particular voltage (e.g., a fast-charging signal) to the external power supply device 420. For example, the docking device 410 may control a switch connected to the external power supply device 420, and may change the electrical path of the external power supply device 420. The docking device 410 may control the switch connected to the external power supply device 420, and may control the external power supply device 420 to establish the first electrical path with the first external electronic device 440, or establishes a electrical path that causes the particular voltage (e.g., a fast-charging signal) to be applied to the external power supply device 420.

According to aspects of the disclosure, even when the electrical path of the external power supply device 420 is changed, the first external electronic device 440 may be continuously supplied with power by the external power supply device 420. This is because the external power supply device 420 may not provide fast charging when the particular voltage (e.g., a fast-charging signal) is not provided to the external power supply device 420 through the D+ line or when the connection of the Vbus line is disconnected, and thus the first external electronic device 440 may need to apply the particular voltage (e.g., a fast-charging signal) to the D+ line connected to the external power supply device 420 so that the first external electronic device 440 may be supplied with power by the external power supply device 420.

When the first external electronic device 440 applies the particular voltage (e.g., a fast charging signal) to the D+ line, the first external electronic device 440 may not perform data communication. Accordingly, the docking device 410 may apply the particular voltage (e.g., a fast charging signal) to the external power supply device 420 instead of the first external electronic device. Specifically, since the first external electronic device 440 is connected to the external power supply device 420 through the docking device 410, the docking device 410 may control the switch connected to the external power supply device 420 and may establish a electrical path which causes the particular voltage (e.g., a fast-charging signal) to be applied to the external power supply device 420. In such instances, the first external electronic device 440 does not need to apply the particular voltage (e.g., a fast-charging signal) to the D+ line.

The docking device 410 may change the electrical path of the external power supply device 420, and may then disconnect the first electrical path. For example, when a first reference time period (e.g., 1 to 1.5 seconds) passes after the first electrical path is established, the docking device 410 may determine that an identification operation is completed by at least one of the first external electronic device 440 and the external power supply device 420. Additionally or alternatively, when the docking device 410 determines that the identification operation has been completed, the docking device 410 may disconnect the first electrical path.

The docking device 410 may change a electrical path of the first external electronic device 440 to a second electrical path for data communication. The docking device 410 may control a switch connected to the first external electronic device 440, and may establish the first electrical path between the first external electronic device and the external power supply device 420 or the second electrical path between the first external electronic device and the second external electronic device 450.

The second electrical path may be a path for data communication. In such instances, the first external electronic device 440 may perform data communication with the second external electronic device 450 through the second electrical path while being supplied with power by the external power supply device 420.

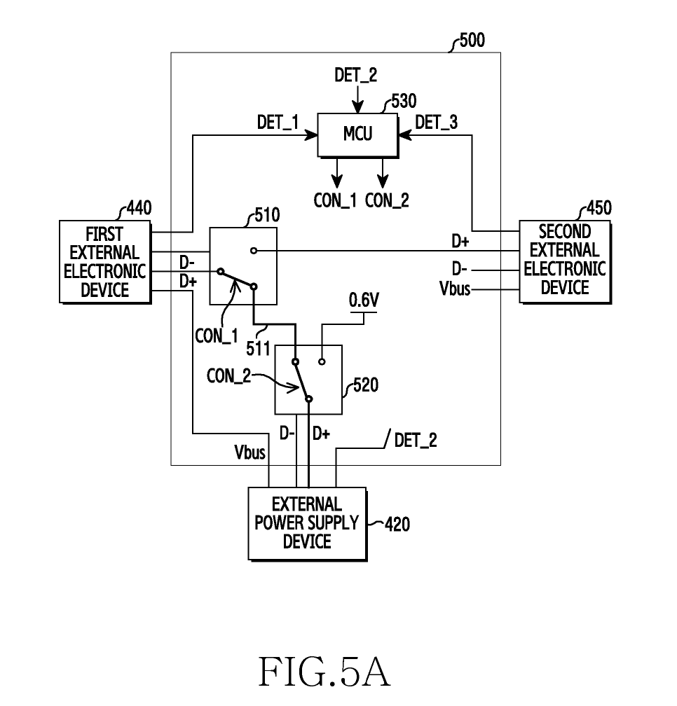

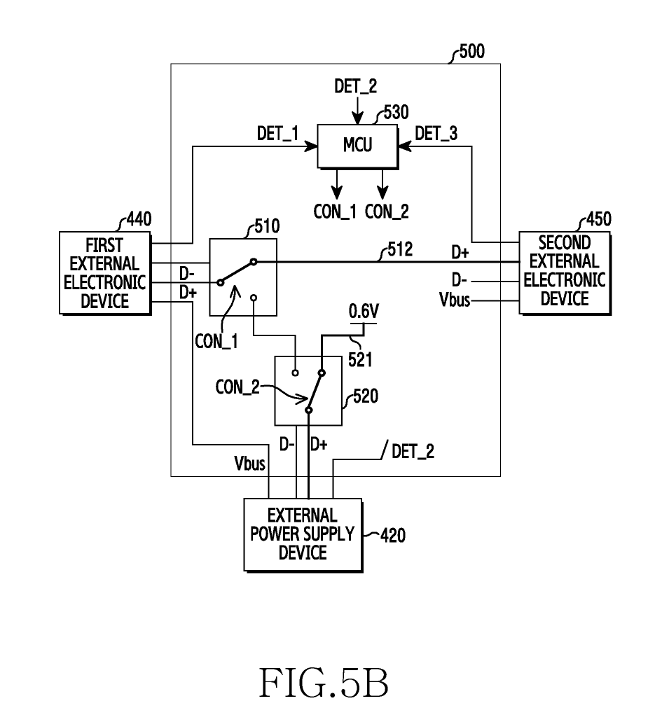

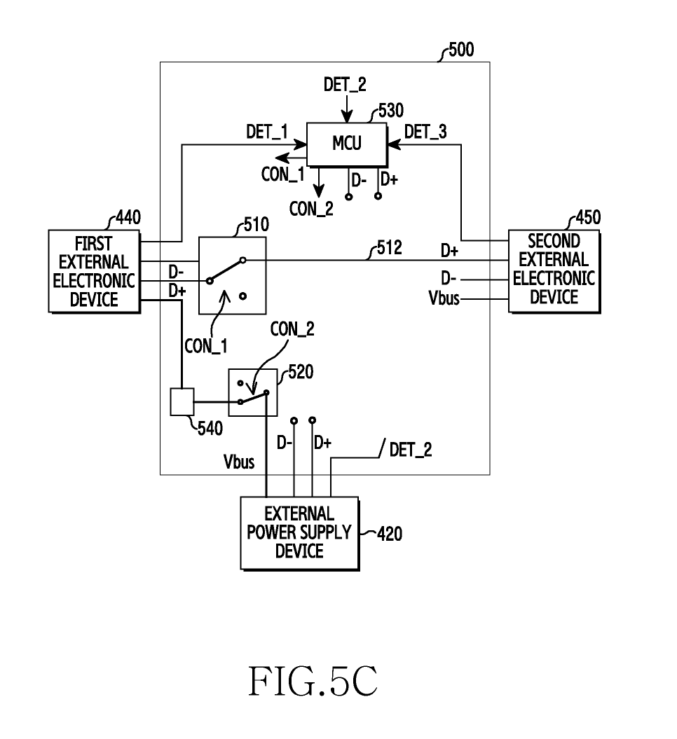

FIGS. 5A-C are circuit diagrams of different examples of docking devices, according to various embodiments of the present disclosure.

Referring to FIGS. 5A to 5C, a docking device 500 may include a first switch module 510, a second switch module 520, and a Microcontroller Unit (MCU) 530. The first switch module 510 may be connected to the first external electronic device 440 through the first interface unit 411. The second switch module 520 may be connected to the external power supply device 420 through the second interface unit 412. The first switch module 510 and the second switch module 520 may control a switch according to the control of the MCU 530.

The MCU 530 (i.e., control circuit) may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. The MCU (i.e., a control circuit) 530 may detect whether the first external electronic device 440 is connected, through a first detection line DET_1 of the first interface unit 411. When an interface (e.g., the input/output interface 150 and the interface 270) of the first external electronic device 440 is connected to the first detection line DET_1, the MCU 530 may detect that the first external electronic device 440 is connected. The MCU 530 may detect whether the external power supply device 420 is connected, through a second detection line DET_2 of the second interface unit 412. When an interface of the external power supply device 420 is connected to the second detection line DET_2, the MCU 530 may detect that the external power supply device 420 is connected. The MCU 530 may detect whether the second external electronic device 450 is connected, through a third detection line DET_3 of the third interface unit 413. When an interface (e.g., the interface 270) of the second external electronic device 450 is connected to the third detection line DET_3, the MCU 530 may determine that the second external electronic device 450 is connected.

Although not illustrated, the docking device 500 may be configured to include a first switch module 510, a second switch module 520, and an MCU 530 within a housing (or a main body). According to various embodiments of the present disclosure, the docking device 500 may further include the external power supply device 420.

FIG. 5A is a diagram illustrating an example in which the docking device 500 establishes a first electrical path according to various embodiments of the present disclosure.

Referring to FIG. 5A, when the first external electronic device 440 and the external power supply device 420 are first (or initially) connected, the MCU 530 may establish the first electrical path 511 between the first external electronic device 440 and the external power supply device 420 by using the first switch module 510 and the second switch module 520. For example, the MCU 530 may control the first switch module 510 so that a D+ line of the first external electronic device 440 may be connected to the first electrical path 511. The MCU 530 may transmit, to the first switch module 510, a first control signal CON_1 for establishing the first electrical path 511. According to the first control signal CON_1, the first switch module 510 may be controlled so that the D+ line of the first external electronic device 440 may be connected to the first electrical path 511. Also, the MCU 530 may control the second switch module 520 so that a D+ line of the external power supply device 420 may be connected to the first electrical path 511. The MCU 530 may transmit, to the second switch module 520, a second control signal CON_2 for establishing the first electrical path 511. According to the second control signal CON_2, the second switch module 520 may be controlled so that the D+ line of the external power supply device 420 may be connected to the first electrical path 511.

According to various embodiments of the present disclosure, the first electrical path 511 may be a path which causes the D+ line of the first external electronic device 440 and the D+ line of the external power supply device 420 to be connected to each other. When the first electrical path 511 is established, the first external electronic device 440 and the external power supply device 420 may perform an identification operation in order for them to identify each other. When the first external electronic device 440 identifies the connection thereof to the external power supply device 420 and the external power supply device 420 identifies the connection thereof to the first external electronic device 440, the first external electronic device 440 may be supplied with power by the external power supply device 420. For example, the first external electronic device 440 may receive a fast-charging voltage (e.g., 9 V) from the external power supply device 420 through a Vbus line.

When an identification operation is completed by at least one of the first external electronic device 440 and the external power supply device 420 (e.g., when the external power supply device 420 has identified the first external electronic device 440 via a signal provided over the D+ line), the MCU 530 may change a electrical path of the external power supply device 420, and may disconnect the first electrical path 511. In some implementations, the external power supply device may need to identify the first external electronic device in order to determine what voltage needs to be supplied to the first external electronic device.

According to aspects of the disclosure, when a first reference time period (e.g., 1 to 1.5 seconds, and/or another time period that is considered sufficient for the identification operation to be performed) passes after the first electrical path 511 is established, the docking device 500 may determine that the identification operation has been completed. After the identification operation is completed, the MCU 530 may disconnect the first electrical path 511. Alternatively, the MCU 530 may change the electrical path of the external power supply device 420, and may then disconnect the first electrical path 511.

According to various embodiments of the present disclosure, after the identification operation is completed, the MCU 530 may maintain the first electrical path. Thereafter, when it is sensed that the second external electronic device 450 is connected, the MCU 530 may change the electrical path of the external power supply device 420, and may disconnect the first electrical path 511. Specifically, the MCU 530 may maintain the first electrical path before the second external electronic device 450 is connected, and may disconnect the first electrical path 511 when the second external electronic device 450 is connected. When it is sensed that the second external electronic device 450 is connected, the MCU 530 may disconnect the first electrical path 511, and may establish a second electrical path 512 between the first external electronic device 440 and the second external electronic device 450.

FIG. 5B is a diagram illustrating an example in which the docking device 500 establishes a second electrical path according to various embodiments of the present disclosure.

Referring to FIG. 5B, in order to be continuously supplied with power (e.g., a fast charging voltage) from the external power supply device 420 even after the first electrical path 511 is disconnected, the first external electronic device 440 needs to apply a fast-charging signal (e.g., 0.6 V) to the D+ line of the external power supply device 420. To this end, the MCU 530 may control the second switch module 520 in order to apply the particular voltage (e.g., a fast-charging signal) to the D+ line of the external power supply device 420. The MCU 530 may transmit, to the second switch module 520, a second control signal CON_2 for applying the particular voltage (e.g., a fast-charging signal) to the D+ line of the external power supply device 420. According to the second control signal CON_2, the second switch module 520 may switch the D+ line of the external power supply device 420 to a electrical path 521. The electrical path 521 may be a path which causes the particular voltage (e.g., a fast-charging signal) to be applied to the D+ line of the external power supply device 420.

In such instances, the D+ line of the first external electronic device 440 and the D+ line of the external power supply device 420 are no longer connected to each other, and thus, the D+ line of the first external electronic device 440 may be used to establish a data communication path. The MCU 530 may control the first switch module 510 so that the D+ line of the first external electronic device 440 may be used for a line for data communication. The MCU 530 may transmit, to the first switch module 510, a first control signal CON_1 for establishing a second electrical path 512. According to the first control signal CON_1, the first switch module 510 may switch the D+ line of the first external electronic device 440 to the second electrical path 512. The second electrical path 512 may be a path established for data communication with the second external electronic device 450.

Even when the second electrical path 512 is established, the first external electronic device 440 may be supplied with power by the external power supply device 420 through the Vbus line. When the second electrical path 512 is established, the first external electronic device 440 may detect whether the second external electronic device 450 is connected. When the second external electronic device 450 is connected, the first external electronic device 440 may perform data communication with the second external electronic device 450. When the second external electronic device 450 is not connected, the first external electronic device 440 may wait for data communication so as to enable data communication immediately after the second external electronic device 450 is connected.

According to various embodiments of the present disclosure, the docking device may be configured to select at least one of multiple voltages having respective voltage levels on the basis of the identification of the first external electronic device and to provide the selected voltage to the first external electronic device.

FIG. 5C is a diagram illustrating an example in which the docking 500 further includes a booster circuit according to various embodiments of the present disclosure.

Referring to FIG. 5C, the docking device 500 may include the first switch module 510, the second switch module 520, the MCU 530, and the booster circuit 540. When the external power supply device 420 is a normal charger, the MCU 530 may boost voltage, which is provided by the external power supply device 420, by using the booster circuit 540. In such instances, the docking device 500 may select at least one of multiple voltages having respective voltage levels on the basis of the identification of the first external electronic device 440 and may provide the selected voltage to the first external electronic device 440. For example, the docking device 500 may further include the booster circuit 540 in between the first external electronic device 440 and the external power supply device 420.

When the docking device 500 further includes the booster circuit 540, the MCU 530 may be directly connected to the external power supply device 420. For example, a D+ line of the MCU 530 may be connected to a D+ line of the external power supply device 420, and a D− line of the MCU 530 may be connected to a D− line of the external power supply device 420. When the MCU 530 is connected to the external power supply device 420, the MCU 530 may control the second switch module 520. The MCU 530 may transmit a second control signal CON_2 to the second switch module 520, and may provide the booster circuit 540 with a voltage supplied from the external power supply device 420.

The booster circuit 540 may boost the voltage supplied from the external power supply device 420 and to provide the boosted voltage to the first external electronic device 440. For example, when the voltage supplied from the external power supply device 420 is not a fast charging voltage (e.g., 9 V) but is a normal charging voltage (e.g., 5 V), the booster circuit 540 may boost the normal charging voltage, which is supplied from the external power supply device 420, into the fast charging voltage. The first external electronic device 440 may receive the voltage (e.g., the fast charging voltage) after being boosted by the booster circuit 540. Accordingly, even when the external power supply device 420 is a normal charger, the docking device 500 may provide the fast charging voltage to the first external electronic device 440.

An electronic device, according to various embodiments of the present disclosure, may further include a housing; a first interface unit that is exposed through a first part of the housing and is connected to an external power supply device; a second interface unit that is exposed through a second part of the housing and is connected to a first external electronic device; and a control circuit, wherein, when the first interface unit is connected to the external power supply device and the second interface unit is connected to the first external electronic device, the control circuit may be configured to establish a first electrical path between the first interface unit and the second interface unit for identifying the external power supply device and/or the first external electronic device; to disconnect the first electrical path after the identification is completed; and to provide information and/or an electrical signal to the first interface unit when the first external electronic device is electrically connected to the first interface unit, while power is supplied from the external power supply device to the first external electronic device.

The control circuit may be configured to establish a second electrical path between the second interface unit and a second external electronic device for data communication.

The electronic device may further include a third interface unit that is exposed through a third part of the housing and is connected to the second external electronic device, and the control circuit may be configured to establish a second electrical path for data communication between the first external electronic device and the second external electronic device while power is supplied from the external power supply device to the first external electronic device.

The control circuit may be configured to change a electrical path of the external power supply device to a electrical path for applying a particular voltage (e.g., a fast-charging signal) to the external power supply device and to disconnect the connection of the first electrical path, when the identification is completed.

The control circuit may be configured to change the first electrical path of the first external electronic device to the second electrical path for data communication when identification between the external power supply device and the first external electronic device is completed.

The electronic device may further include a first switch module that is connected to the second interface unit and changes a electrical path of the first external electronic device, and the control circuit may be configured to control the first switch module to change the electrical path of the first external electronic device.

The electronic device may further include a second switch module that is connected to the first interface unit and changes a electrical path of the external power supply device, and the control circuit may be configured to control the second switch module to change the electrical path of the external power supply device.

The electronic device may further include a booster circuit that boosts a voltage supplied from the external power supply device, and the control circuit may be configured to provide the boosted voltage to the first external electronic device. The external power supply device may be configured to select at least one of multiple voltages having respective voltage levels based on the identification of the first external electronic device and to provide the selected voltage to the first external electronic device.

The electronic device may further include multiple interface units that are connected to multiple second external electronic devices; and a hub that controls data communication between the multiple second external electronic devices, that are connected through the multiple interface units, and the first external electronic device.

An electronic device, according to various embodiments of the present disclosure, may include a communication interface; a memory; and a processor that is functionally connected to the communication interface and the memory, wherein the processor may be configured to be supplied with power by an external power supply device when the processor is connected to the external power supply device, and to perform data communication with an external electronic device while the processor is supplied with the power.

The processor may be configured to determine whether data communication is being performed with the external electronic device when contact with the external power supply device is detected, and to control the data communication with the external electronic device, based on a result of the determination.

The processor may be configured to stop the data communication with the external electronic device when the data communication is being performed with the external electronic device, and to attempt to make a connection with the external power supply device.

The processor may be configured to resume data communication with the external electronic device when the connection with the external power supply device is completed.

The processor may be configured to prevent power from being received from the external electronic device and to be supplied with power by the external power supply device, when the processor is connected to the external power supply device.

An electronic device, according to various embodiments of the present disclosure, may include a housing; a first electrical interface that is exposed through a first part of the housing and is connected to an external power supply device; a second electrical interface that is exposed through a second part of the housing and is connected to a first external electronic device; and a control circuit, wherein, when the second electrical interface is connected to the first external electronic device, the control circuit may be configured to establish a first electrical path to the second electrical interface for identifying the first external electronic device; to disconnect an electrical connection with the first electrical path after the identification is completed; and to establish a second electrical path between the second electrical interface and a second external electronic device for data communication, while power is supplied from the external power supply device to the first external electronic device.

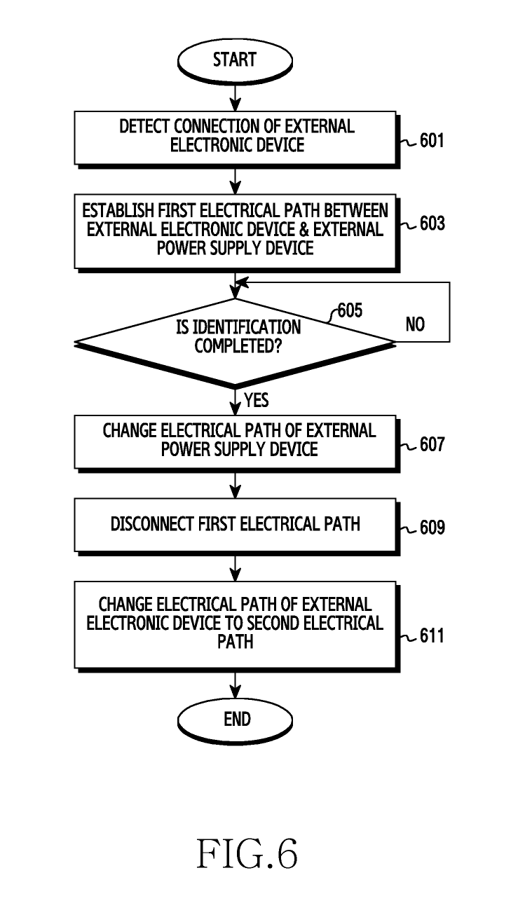

FIG. 6 is a flowchart of an example of a process, according to various embodiments of the present disclosure.

Referring to FIG. 6, in operation 601, the docking device 500 (e.g., the MCU 530) may detect a connection of an external electronic device (e.g., the first external electronic device 440). According to various embodiments of the present disclosure, the MCU 530 may detect whether the first external electronic device 440 is connected, through the first detection line DET_1 of the first interface unit 411. For example, when an interface (e.g., the interface 270) of the first external electronic device 440 is connected to the first detection line DET_1, the MCU 530 may determine that the first external electronic device 440 is connected.

In operation 603, the MCU 530 may establish a first electrical path between the first external electronic device 440 and the external power supply device 420. When the first external electronic device 440 and the external power supply device 420 are first (or initially) connected, the MCU 530 may establish the first electrical path 511 between the first external electronic device 440 and the external power supply device 420 by using the first switch module 510 and the second switch module 520. For example, the MCU 530 may transmit, to the first switch module 510, a first control signal CON_1 for establishing the first electrical path 511, and according to the first control signal CON_1, the first switch module 510 may be controlled so that the D+ line of the first external electronic device 440 may be connected to the first electrical path 511. Also, the MCU 530 may transmit, to the second switch module 520, a second control signal CON_2 for establishing the first electrical path 511, and according to the second control signal CON_2, the second switch module 520 may be controlled so that the D+ line of the external power supply device 420 may be connected to the first electrical path 511. Accordingly, the first electrical path 511 may be a path which causes the D+ line of the first external electronic device 440 and the D+ line of the external power supply device 420 to be connected to each other.

In operation 605, the MCU 530 may determine whether an identification operation is completed by at least one of the first external electronic device 440 and the external power supply device 420. When the first electrical path 511 is established, the first external electronic device 440 and the external power supply device 420 may perform an identification operation in order to identify each other. The first external electronic device 440 may identify the external power supply device 420 through the first electrical path 511. Also, the external power supply device 420 may identify the first external electronic device 440 through the first electrical path 511. For example, when a first reference time period (e.g., 1 to 1.5 seconds) passes after the first electrical path 511 is established, the MCU 530 may determine that the identification operation has been completed.

When the identification operation has been completed, in operation 607, the MCU 530 may change a electrical path of the external power supply device 420. In order to allow the first external electronic device 440 to be continuously supplied with power by the external power supply device 420 even after the first electrical path 511 is disconnected, the MCU 530 may change the electrical path of the external power supply device 420. To this end, the MCU 530 may control the second switch module 520 in order to apply a particular voltage (e.g., a fast-charging signal) to the D+ line of the external power supply device 420. The MCU 530 may transmit, to the second switch module 520, a second control signal CON_2 for applying the particular voltage (e.g., a fast-charging signal), and according to the second control signal CON_2, the second switch module 520 may switch the D+ line of the external power supply device 420 to a electrical path 521. The electrical path 521 may be a path which causes the particular voltage (e.g., a fast-charging signal) to be applied to the D+ line of the external power supply device 420.

In operation 609, the MCU 530 may disconnect the connection of the first electrical path 511. Even when the connection of the first electrical path 511 is disconnected, the first external electronic device 440 may be supplied with power by the external power supply device 420. For example, since the particular voltage (e.g., a fast-charging signal) is applied to the D+ line of the external power supply device 420, the external power supply device 420 may recognize a current state when the external power supply device 420 is continuously connected to the first external electronic device 440. Accordingly, the external power supply device 420 may continuously supply a fast-charging voltage (e.g., 9 V) to the first external electronic device 440 through a Vbus line.

In operation 611, while the external power supply device 420 supplies the first external electronic device 440 with power, the MCU 530 may change a electrical path of the first external electronic device 440 to a second electrical path 512 for data communication. When the second electrical path 512 is established, if there exists an external device (e.g., the second external electronic device 450) connected to the docking device 500, the first external electronic device 440 may perform data communication with the second external electronic device 450. Accordingly, after the identification operation is completed by at least one of the first external electronic device 440 and the external power supply device 420 (e.g., after operation 605), the first external electronic device 440 may be continuously supplied with power by the external power supply device 420. The first external electronic device 440 may perform data communication with the second external electronic device 450 while being supplied with power (e.g., a fast charging voltage) from the external power supply device 420.

Although operations 607 to 611 are illustrated as being distinguished from each other in FIG. 6, operations 607 to 611 may be performed regardless of sequential order, or may be simultaneously (or concurrently) performed. Specifically, the MCU 530 may disconnect the first electrical path 511 and may simultaneously (or concurrently) change a electrical path of the external power supply device 420, and may establish the first external electronic device 440 as the second electrical path 512. Alternatively, the MCU 530 may change the electrical path of the external power supply device 420 and may establish the first external electronic device 440 as the second electrical path 512, and thereby may disconnect the first electrical path 511 as a result.

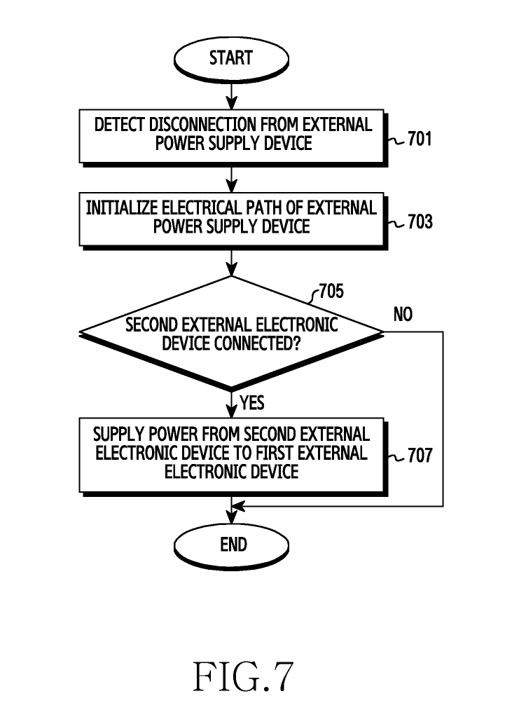

FIG. 7 is a flowchart of an example of a process, according to various embodiments of the present disclosure.

Referring to FIG. 7, in operation 701, the docking device 500 (e.g., the MCU 530) may detect a disconnection of the docking device 500 from the external power supply device 420. The docking device 500 may be basically in a state of being connected to the external power supply device 420. Accordingly, the docking device 500 may be supplied with power, which is required to perform an operation of the MCU 530, from the external power supply device 420. Also, when the first external electronic device 440 is connected to the docking device 500, the external power supply device 420 may also supply the first external electronic device 440 with power.

According to various embodiments of the present disclosure, when the docking device 500 is disconnected from the external power supply device 420, the docking device 500 needs to determine a subject that is to supply the docking device 500 with power required to perform an operation thereof, and needs to determine a subject that is to supply the first external electronic device 440 with power.

When the docking device 500 is disconnected from the external power supply device 420, in operation 703, the MCU 530 may initialize a electrical path of the external power supply device 420. When the first external electronic device 440 is connected to the docking device 500, the external power supply device 420 may be configured to be connected to a electrical path 521, to which a particular voltage (e.g., a fast-charging signal) is applied, except for an initial time period. For example, initially, the MCU 530 may establish a electrical path of the external power supply device 420 as a first electrical path 511. Thereafter, when an identification operation is completed by at least one of the external power supply device 420 and the first external electronic device 440, the MCU 530 may change the electrical path of the external power supply device 420 from the first electrical path 511 to the electrical path 521. When the connection of the first external electronic device 440 is disconnected, or when the connection of the docking device 500 with the external power supply device 420 is not disconnected, the MCU 530 may maintain the electrical path of the external power supply device 420 as the electrical path 521.

When the connection of the docking device 500 with the external power supply device 420 is disconnected, the MCU may initialize the electrical path of the external power supply device 420 to the first electrical path 511.

In operation 705, the MCU 530 may determine whether the docking device 500 is connected to the second external electronic device 450.

When the docking device 500 is connected to the second external electronic device 450, the MCU 530 may perform operation 707. When the docking device 500 is not connected to the second external electronic device 450, the MCU 530 may end the process. The docking device 500 is supplied with power by the external power supply device 420, and does not have a subject that is to supply power to the docking device 500. Accordingly, the MCU 530 may not be supplied with the power required to perform an operation of the MCU 530, and may be turned off.

When the docking device 500 is connected to the second external electronic device 450, in operation 707, the MCU 530 may cause the second external electronic device 450 to supply the first external electronic device 440 with power. In such instances, the MCU 530 may connect a Vbus line of the second external electronic device 450 with a Vbus line of the first external electronic device 440, and may cause the first external electronic device 440 to be supplied with power by the second external electronic device 450. Also, the MCU 530 may be supplied with power, that the MCU 530 itself requires, from the second external electronic device 450. To this end, the MCU 530 may change a power supply line from the external power supply device 420 to the second external electronic device 450.

According to various embodiments of the present disclosure, when the docking device 500 is reconnected to the external power supply device 420 after operation 707, the MCU 530 may establish the first electrical path 511 between the first external electronic device 440 and the external power supply device 420. The MCU 530 may be supplied with power, that the MCU 530 itself requires, from the external power supply device 420. To this end, the MCU 530 may change a power supply line from the second external electronic device 450 to the external power supply device 420. After the first electrical path 511 is established, the MCU 530 may perform operations 605 to 611 described with reference to FIG. 6.

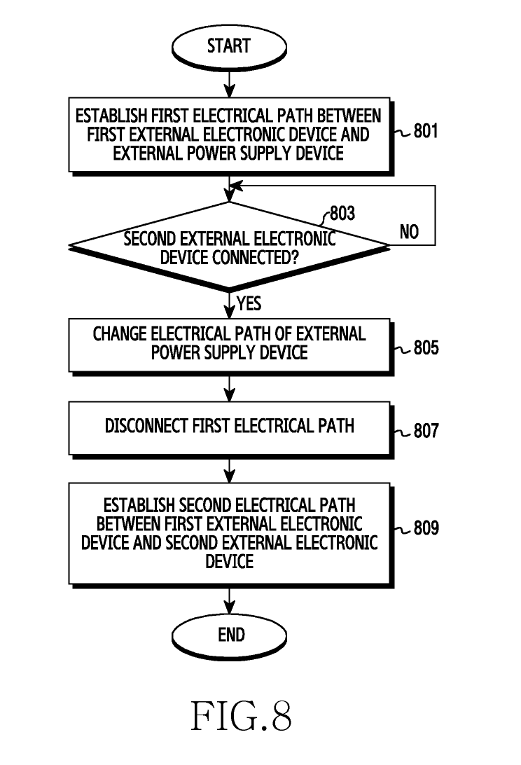

According to various embodiments of the present disclosure, the docking device 500 may be basically in a state of being connected to the second external electronic device 450. When the docking device 500 is basically connected to the second external electronic device 450, the docking device 500 may be supplied with required power by the second external electronic device 450. Alternatively, the docking device 500 may be basically in a state of being connected to the external power supply device 420. When the docking device 500 is basically connected to the external power supply device 420, the docking device 500 may be supplied with required power by the external power supply device 420. Hereinafter, FIG. 8 illustrates operations which may be performed when the docking device 500 is basically connected to the external power supply device 420.

FIG. 8 is a flowchart of an example of a process, according to various embodiments of the present disclosure.

Referring to FIG. 8, in operation 801, the docking device 500 (e.g., the MCU 530) may establish a first electrical path 511 between the first external electronic device 440 and the external power supply device 420. Operation 801 is identical or similar to operation 603 illustrated in FIG. 6, and thus, a detailed description thereof will be omitted. According to various embodiments of the present disclosure, the MCU 530 may determine whether identification of at least some of the devices has been completed, through the first electrical path 511. When the identification has been completed, the MCU 530 may perform operation 803.

In operation 803, the MCU 530 may determine whether the docking device 500 is connected to the second external electronic device 450. The docking device 500 may be basically in a state of being connected to the external power supply device 420. When the docking device 500 is basically connected to the external power supply device 420, the docking device 500 may be supplied with required power by the external power supply device 420.

When the docking device 500 is connected to the second external electronic device 450, the MCU 530 may perform operation 805. When the identification has been completed, if the docking device 500 is not connected to the second external electronic device 450, the MCU 530 may not disconnect the first electrical path 511, but may maintain the first electrical path 511. For example, when the first electrical path 511 is maintained, a D+ line of the external power supply device 420 and a D+ line of the first external electronic device 440 may maintain a electrical path. Specifically, the MCU 530 may determine whether the first electrical path 511 is disconnected, according to whether the second external electronic device 450 is connected.

According to various embodiments of the present disclosure, the MCU 530 may cause the first external electronic device 440 to be in a state (e.g., formation of a second electrical path) of being capable of performing data communication, regardless of whether the second external electronic device 450 is connected, as in operation 611 illustrated in FIG. 6. In such instances, when the second external electronic device 450 is connected to the docking device 500, the first external electronic device 440 may immediately perform data communication. Alternatively, the MCU 530 may cause the first external electronic device 440 to be in the state (e.g., formation of the second electrical path) of being capable of performing data communication, according to whether the second external electronic device 450 is connected.

When the docking device 500 is connected to the second external electronic device 450, in operation 805, the MCU 530 may change a electrical path of the external power supply device 420. In order to allow the first external electronic device 440 to be continuously supplied with power by the external power supply device 420 even after the first electrical path 511 is disconnected, the MCU 530 may change the electrical path of the external power supply device 420. To this end, the MCU 530 may control the second switch module 520 in order to apply a particular voltage (e.g., a fast-charging signal) to the D+ line of the external power supply device 420. The MCU 530 may transmit, to the second switch module 520, a second control signal CON_2 for applying the particular voltage (e.g., a fast-charging signal), and according to the second control signal CON_2, the second switch module 520 may switch the D+ line of the external power supply device 420 to a electrical path 521. The electrical path 521 may be a path which causes the particular voltage (e.g., a fast-charging signal) to be applied to the D+ line of the external power supply device 420.

In operation 807, the MCU 530 may disconnect the connection of the first electrical path 511. For example, the electrical path of the external power supply device 420 has been changed in operation 805, and thus, the particular voltage (e.g., a fast-charging signal) is continuously applied to the D+ line of the external power supply device 420. In such instances, the external power supply device 420 may recognize that it is continuously connected to the first external electronic device 440. Accordingly, the external power supply device 420 may continuously supply a fast-charging voltage (e.g., 9 V) to the first external electronic device 440 through a Vbus line. Therefore, the MCU 530 may disconnect the connection of the first electrical path 511 so as to enable the first external electronic device 440 to perform data communication.

In operation 809, while the external power supply device 420 supplies the first external electronic device 440 with power, the MCU 530 may establish a second electrical path 512 between the first external electronic device 440 and the second external electronic device 450. When the second electrical path 512 is established, the first external electronic device 440 may perform data communication with the second external electronic device 450. Accordingly, after a electrical path between the first external electronic device 440 and the external power supply device 420 is established, the first external electronic device 440 may be continuously supplied with power by the external power supply device 420. The first external electronic device 440 may perform data communication with the second external electronic device 450 while being supplied with power (e.g., a fast charging voltage) from the external power supply device 420.

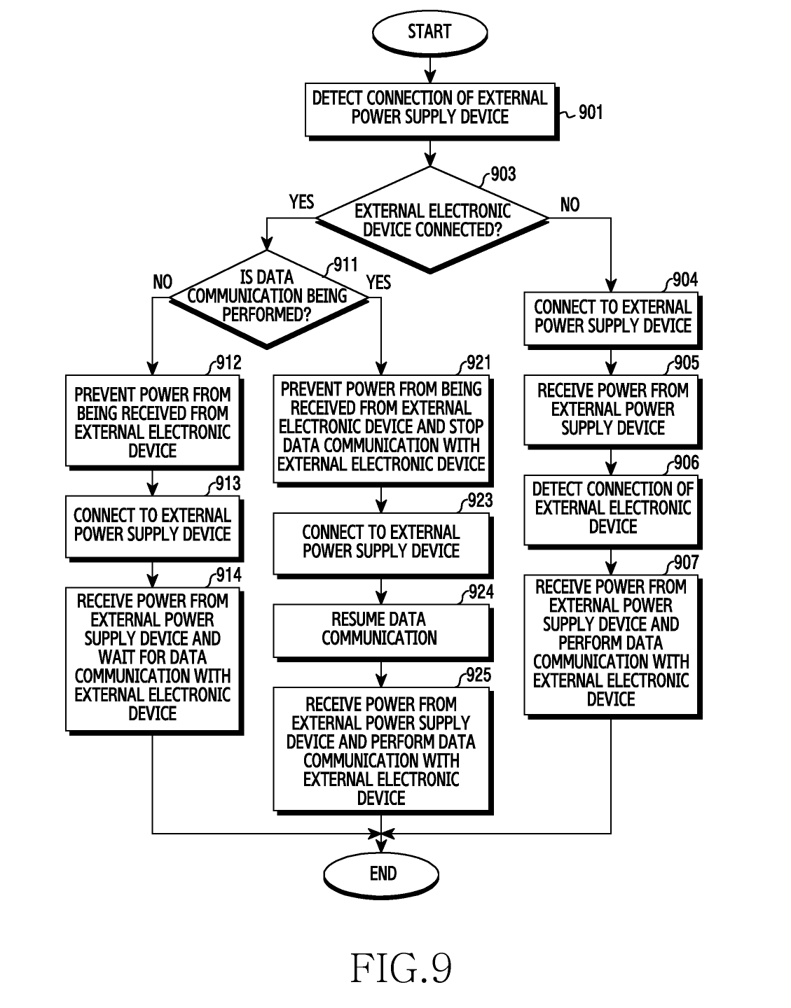

FIG. 9 is a flowchart of an example of a process, according to various embodiments of the present disclosure.

Referring to FIG. 9, in operation 901, the electronic device 101 (e.g., the first external electronic device 440) may detect a connection of the external power supply device 420. The processor 120 of the electronic device 101 may detect whether an interface unit of the external power supply device 420 is connected to a detection line of an interface (e.g., the input/output interface 150 and the interface 270). The external power supply device 420 may be connected to the electronic device 101 through the docking device 500.

In operation 903, the processor 120 may determine whether the electronic device 101 is connected to an external electronic device (e.g., the second external electronic device 450). When the electronic device 101 is connected to the second external electronic device 450, the processor 120 may perform operation 911. When the electronic device 101 is not connected to the second external electronic device 450, the processor 120 may perform operation 904.

First, when the electronic device 101 is not connected to the second external electronic device 450, in operation 904, the processor 120 may connect to the external power supply device 420. For example, the processor 120 and the external power supply device 420 may establish a electrical path (e.g., a first electrical path 511) for transmitting power from the external power supply device 420 to the processor 120. The processor 120 may be connected to the external power supply device 420 through the docking device 500. Specifically, the docking device 500 may establish the first electrical path 511 between the processor 120 and the external power supply device 420.

In operation 905, when the connection of the processor 120 with the external power supply device 420 has been completed, the processor 120 may receive power from the external power supply device 420.

In operation 906, the processor 120 may detect the connection of the electronic device 101 with the second external electronic device 450. The processor 120 may detect the connection of the electronic device 101 with the second external electronic device 450 while being supplied with power by the external power supply device 420. When the connection of the electronic device 101 with the second external electronic device 450 has been detected, the processor 120 may prepare for data communication with the second external electronic device 450. For example, the docking device 500 may establish a second electrical path 512 so as to enable the electronic device 101 to perform data communication with the second external electronic device 450.

In operation 907, the processor 120 may receive power from the external power supply device 420, and may perform data communication with the second external electronic device 450. For example, the processor 120 may exchange various types of data (e.g., text, an image, a moving image, multimedia content, etc.) with the second external electronic device 450 through the communication interface 170.

When the electronic device 101 is connected to the second external electronic device 450, in operation 911, the processor 120 may determine whether the electronic device 101 is performing data communication with the second external electronic device 450.

When the electronic device 101 is performing data communication with the second external electronic device 450, the processor 120 may perform operation 921. When the electronic device 101 is not performing data communication with the second external electronic device 450, the processor 120 may perform operation 912.

First, when the electronic device 101 is not performing data communication with the second external electronic device 450, in operation 912, the processor 120 may prevent power from being received from the second external electronic device 450. When the electronic device 101 is being connected to the second external electronic device 450 before being connected to the external power supply device 420, the processor 120 may be supplied with power from the second external electronic device 450. At this time, when the electronic device 101 is connected to the external power supply device 420, the processor 120 may stop the reception of power from the second external electronic device 450, and may prepare for the reception of power from the external power supply device 420. For example, with respect to a priority of a subject from which the processor 120 receives power, the external power supply device 420 may have a higher priority than that of the second external electronic device 450. Alternatively, the reverse is possible.

In operation 913, the processor 120 may connect to the external power supply device 420. For example, the processor 120 and the external power supply device 420 may establish a electrical path (e.g., the first electrical path 511) for transmitting power from the external power supply device 420 to the processor 120. The processor 120 may be connected to the external power supply device 420 through the docking device 500. Specifically, the docking device 500 may establish the first electrical path 511 between the processor 120 and the external power supply device 420.

In operation 914, the processor 120 may receive power from the external power supply device 420, and may wait for data communication with the second external electronic device 450. When the connection of the electronic device 101 with the external power supply device 420 has been completed, the processor 120 may receive power from the external power supply device 420. Also, the processor 120 is being connected to the second external electronic device 450, and thus may wait so as to be capable of performing, at any time, data communication with the second external electronic device 450.

When the electronic device 101 is performing data communication with the second external electronic device 450, in operation 921, the processor 120 may prevent power from being received from the second external electronic device 450, and may stop the data communication with the second external electronic device 450. As described above, with respect to a priority of a subject from which the processor 120 receives power, the external power supply device 420 may have a higher priority than that of the second external electronic device 450. When the external power supply device 420 is connected, the processor 120 may prevent power from being received from the second external electronic device 450, in order to be supplied with power by the external power supply device 420. Also, when the electronic device 101 is connected to the external power supply device 420 while the electronic device 101 is performing data communication with the second external electronic device 450, a electrical path is to be changed by the docking device 500, and thus, the processor 120 may temporarily stop the data communication with the second external electronic device 450.

When the docking device 500 is connected to the external power supply device 420 while the first external electronic device 440 and the second external electronic device 450 are connected, the docking device 500 may initialize a electrical path between the external power supply device 420 and the first external electronic device 440. At this time, when the electrical path is initialized, a electrical path between the first external electronic device 440 and the second external electronic device 450 may not be established. For example, when the electrical path is initialized, the first electrical path 511, to which a D+ line of the first external electronic device 440 and a D+ line of the external power supply device 420 are connected, may be established. In such instances, since the second electrical path 512 is not connected which is established between the first external electronic device 440 and the second external electronic device 450, data communication may not be performed between the first external electronic device 440 and the second external electronic device 450.

When temporal data communication is stopped, the processor 120 may determine that the stop of temporal data communication is an error, and may be required to transmit or receive, again from the beginning, data being transmitted or received. In order to prevent this situation, when the connection of the electronic device 101 with the external power supply device 420 is detected, the processor 120 may temporarily stop the data communication with the second external electronic device 450 In such instances, since the processor 120 knows data being transmitted or received until a time point before the communication is stopped, when a electrical path with the external power supply device 420 is disconnected and a electrical path with the second external electronic device 450 is again established, the processor 120 may transmit or receive data, from the time point before the communication is stopped.

In operation 923, the processor 120 may connect to the external power supply device 420. Operation 923 is identical to operation 913 or operation 904, and thus, a detailed description thereof will be omitted. When the connection of the electronic device 101 with the external power supply device 420 has been completed, the processor 120 may receive power from the external power supply device 420.

In operation 924, the processor 120 may release the stop of data communication with the second external electronic device 450. For example, the processor 120 may resume the transmission/reception of data from the second external electronic device 450.

In operation 925, the processor 120 may receive power from the external power supply device 420, and may perform data communication with the second external electronic device 450. For example, the processor 120 may exchange data with the second external electronic device 450 through the communication interface 170.

An operating method of an electronic device, according to various embodiments of the present disclosure, may include establishing a first electrical path between an external power supply device and a first external electronic device; disconnecting a connection of the first electrical path when identification between the external power supply device and the first external electronic device is completed; and controlling the first external electronic device to transmit a data signal while power is supplied from the external power supply device to the first external electronic device.

The controlling of the first external electronic device may include establishing a second electrical path for data communication with the first external electronic device.

The second electrical path may be a path for data communication between the first external electronic device and a second external electronic device.

The disconnecting of the connection of the first electrical path may include changing a electrical path of the external power supply device to a electrical path for applying a particular voltage (e.g., a fast-charging signal) to the external power supply device, when identification between the external power supply device and the first external electronic device is completed; and disconnecting the connection of the first electrical path when the electrical path of the external power supply device is changed.

The controlling of the first external electronic device may include controlling a first switch module to change a electrical path of the first external electronic device; and controlling a second switch module to change the electrical path of the external power supply device.

The operating method may further include changing the first electrical path of the first external electronic device to a second electrical path for data communication when the identification between the external power supply device and the first external electronic device is completed.

A computer-readable recording medium, according to various embodiments of the present disclosure, may include a program for executing: establishing a first electrical path between an external power supply device and a first external electronic device; disconnecting a connection of the first electrical path when identification between the external power supply device and the first external electronic device is completed; and controlling the first external electronic device to transmit a data signal while power is supplied from the external power supply device to the first external electronic device.

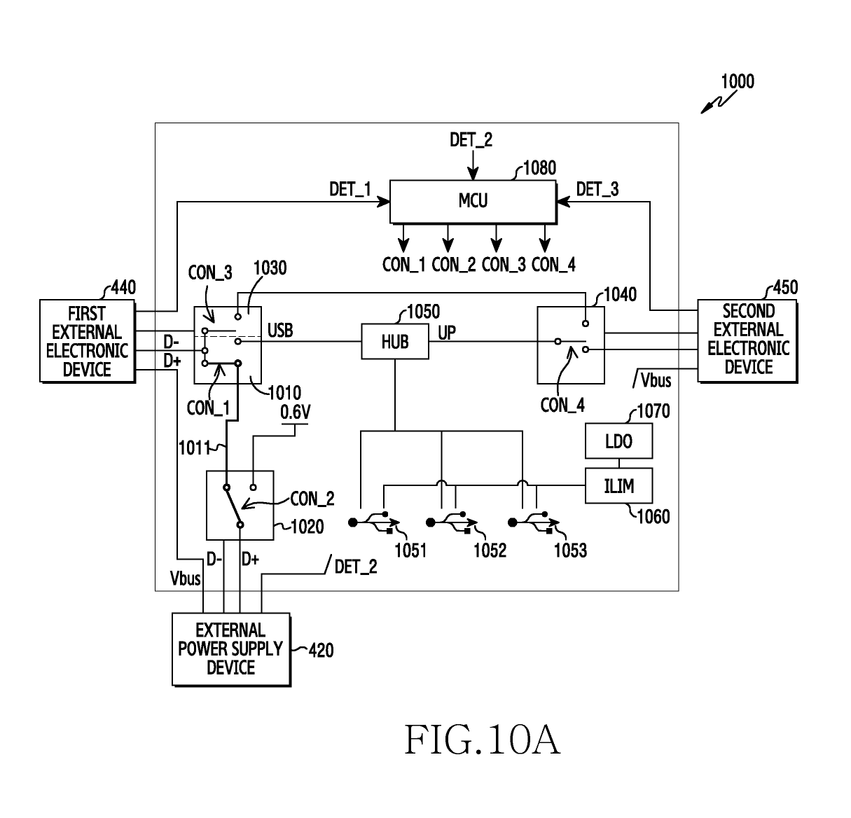

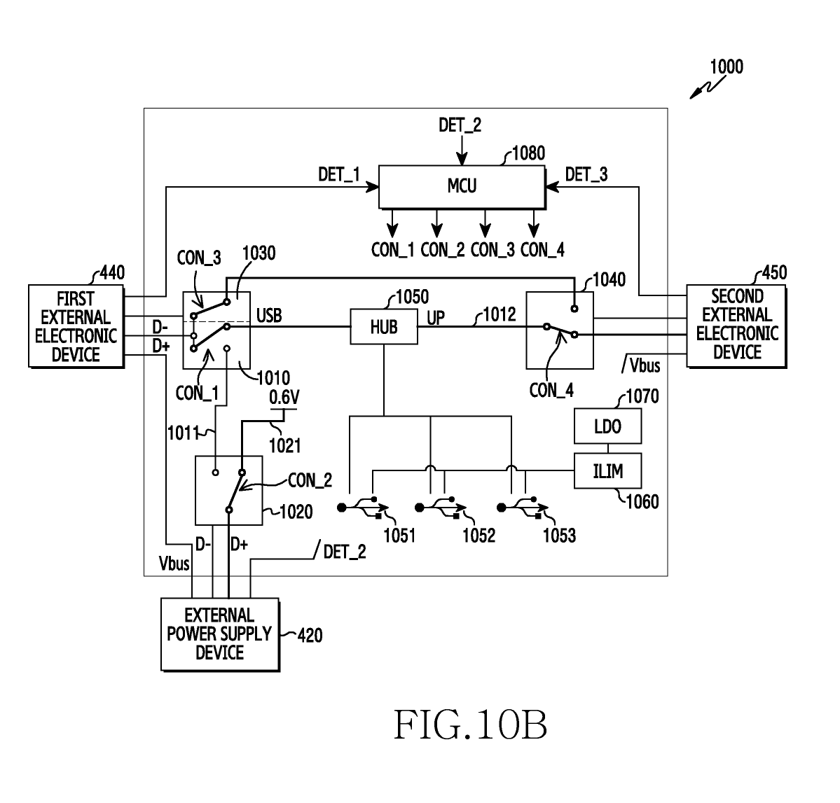

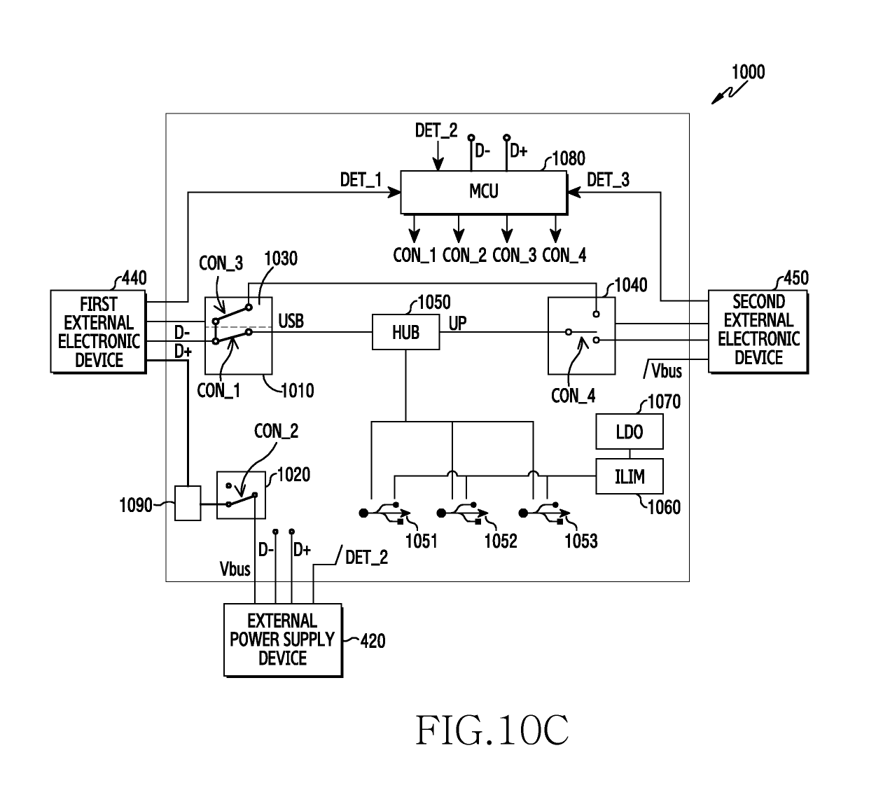

FIGS. 10A-C are circuit diagrams of different examples of docking devices, according to various embodiments of the present disclosure.

FIGS. 10A-C illustrate examples of docking devices 1000, each of which includes multiple interface units that are connected to external devices capable of performing data communication with the first external electronic device 440. For example, the docking device 1000 may include a first switch module 1010, a second switch module 1020, a third switch module 1030, a fourth switch module 1040, a HUB 1050, and an MCU 1080. The first switch module 1010 may be connected to the first external electronic device 440 through the first interface unit 411. The second switch module 1020 may be connected to the external power supply device 420 through the second interface unit 412. The third switch module 1030 may be connected to the first external electronic device 440 through the first interface unit 411. The fourth switch module 1040 may be connected to the second external electronic device 450 through the third interface unit 413. Each of the first switch module 1010 to the fourth switch module 1040 may change a switch, according to the control of the MCU 1080.

The HUB 1050 may serve as an intermediary for a connection with external devices (e.g., a third external electronic device, a keyboard, a speaker, a USB, etc.) other than the second external electronic device 450. The HUB 1050 may include a fourth interface unit 1051, a fifth interface unit 1052, and a sixth interface unit 1053 that are connected to external devices. The HUB 1050 may further include a regulator LDO 1070 and a current limiter ILIM 1060 that control the fourth interface unit 1051, the fifth interface unit 1052, and the sixth interface unit 1053.

FIG. 10A is a diagram illustrating an example in which the docking device 1000 establishes a first electrical path according to various embodiments of the present disclosure.

Referring to FIG. 10A, when the first external electronic device 440 and the external power supply device 420 are first (or initially) connected, the MCU 1080 may establish the first electrical path 1011 between the first external electronic device 440 and the external power supply device 420 by using the first switch module 1010 and the second switch module 1020. For example, the MCU 1080 may control the first switch module 1010 so that a D+ line of the first external electronic device 440 may be connected to the first electrical path 1011. The MCU 1080 may transmit, to the first switch module 1010, a first control signal CON_1 for establishing the first electrical path 1011. According to the first control signal CON_1, the first switch module 1010 may be controlled so that the D+ line of the first external electronic device 440 may be connected to the first electrical path 1011. Also, the MCU 1080 may control the second switch module 1020 so that a D+ line of the external power supply device 420 may be connected to the first electrical path 1011. The MCU 1080 may transmit, to the second switch module 1020, a second control signal CON_2 for establishing the first electrical path 1011. According to the second control signal CON_2, the second switch module 1020 may be controlled so that the D+ line of the external power supply device 420 may be connected to the first electrical path 1011. Accordingly, the first electrical path 1011 may be a path which causes the D+ line of the first external electronic device 440 and the D+ line of the external power supply device 420 to be connected to each other.

In the present example, the MCU 1080 may turn off the third switch module 1030 and the fourth switch module 1040. Each of the third switch module 1030 and the fourth switch module 1040 may change a electrical path for data communication, and FIG. 10A illustrates an example of establishing the first electrical path 1011. Accordingly, both the third switch module 1030 and the fourth switch module 1040 may be turned off. When an identification operation is completed by at least one of the first external electronic device 440 and the external power supply device 420, the MCU 1080 may disconnect the first electrical path 1011.

FIG. 10B is a diagram illustrating an example in which the docking device 1000 establishes a second electrical path according to various embodiments of the present disclosure.

Referring to FIG. 10B, in order to be continuously supplied with power (e.g., a fast charging voltage) from the external power supply device 420 even after the first electrical path 1011 is disconnected, the first external electronic device 440 needs to apply a particular voltage (e.g., a fast-charging signal, such as a 0.6V signal) to the D+ line of the external power supply device 420. To this end, the MCU 1080 may control the second switch module 1020 in order to apply the particular voltage to the D+ line of the external power supply device 420. The MCU 1080 may transmit, to the second switch module 1020, a second control signal CON_2 for applying the particular voltage (e.g., a fast-charging signal). According to the second control signal CON_2, the second switch module 1020 may switch the D+ line of the external power supply device 420 to a electrical path 1021. The electrical path 1021 may be a path which causes the particular voltage (e.g., a fast-charging signal) to be applied to the D+ line of the external power supply device 420.

In such instances, the D+ line of the first external electronic device 440 and the D+ line of the external power supply device 420 are no longer connected to each other, and thus, the D+ line of the first external electronic device 440 may be used to establish a data communication path. The MCU 1080 may control the first switch module 1010 so that the D+ line of the first external electronic device 440 may be used for a line for data communication. The MCU 1080 may transmit, to the first switch module 1010, a first control signal CON_1 for establishing a second electrical path 1012. According to the first control signal CON_1, the first switch module 1010 may switch the D+ line of the first external electronic device 440 to the second electrical path 1012. The second electrical path 1012 may be a path established for data communication with the second external electronic device 450.

Also, the MCU 1080 may control the third switch module 1030 so that the D+ line of the first external electronic device 440 may be used as a line for data communication. The MCU 1080 may transmit, to the third switch module 1030, a control signal CON_3 for data communication. According to the control signal CON_3, the third switch module 1030 may configure the D+ line of the first external electronic device 440 as a electrical path for data communication. For example, the electrical path, which is configured by the third switch module 1030, may correspond to the downlink of data. The MCU 1080 may control the fourth switch module 1040 so that a D+ line of the second external electronic device 450 may be used as a line for data communication. The MCU 1080 may transmit, to the fourth switch module 1040, a control signal CON_4 for data communication. According to the control signal CON_4, the fourth switch module 1040 may configure the D+ line of the second external electronic device 450 as a electrical path for data communication. For example, the electrical path, which is configured by the fourth switch module 1040, may correspond to the downlink of data.

Even when the second electrical path 1012 is established, the first external electronic device 440 may be supplied with power by the external power supply device 420 through a Vbus line. When the second electrical path 1012 is established, the first external electronic device 440 may detect whether the second external electronic device 450 is connected. When the second external electronic device 450 is connected, the first external electronic device 440 may perform data communication with the second external electronic device 450. When the second external electronic device 450 is not connected, the first external electronic device 440 may wait for data communication so as to enable data communication immediately after the second external electronic device 450 is connected.

FIG. 10C is a diagram illustrating an example in which the docking device 1000 further includes a booster circuit according to various embodiments of the present disclosure.

Referring to FIG. 10C, the docking device 1000 may include the first switch module 1010, the second switch module 1020, the MCU 1080, and the booster circuit 1090. When the external power supply device 420 is a normal charger, the MCU 1080 may boost a voltage, which is provided by the external power supply device 420, by using the booster circuit 1090. In such instances, the docking device 1000 may select at least one of multiple supported voltages based on the identity of the first external electronic device 440 and may provide the selected voltage to the first external electronic device 440. For example, the docking device 1000 may further include the booster circuit 1090 in between the external power supply device 420 and the first external electronic device 440.

When the docking device 1000 further includes the booster circuit 1090, the MCU 1080 may be directly connected to the external power supply device 420. For example, a D+ line of the MCU 1080 may be connected to a D+ line of the external power supply device 420, and a D− line of the MCU 1080 may be connected to a D− line of the external power supply device 420. When the MCU 1080 is connected to the external power supply device 420, the MCU 1080 may control the second switch module 1020. The MCU 1080 may transmit a second control signal CON_2 to the second switch module 1020, and may provide the booster circuit 1090 with a voltage supplied from the external power supply device 420.

The booster circuit 1090 may boost the voltage supplied from the external power supply device 420 and to provide the boosted voltage to the first external electronic device 440. For example, when the voltage supplied from the external power supply device 420 is not a fast charging voltage (e.g., 9 V) but is a normal charging voltage (e.g., 5 V), the booster circuit 1090 may boost the normal charging voltage, which is supplied from the external power supply device 420, into the fast charging voltage. The first external electronic device 440 may receive the voltage (e.g., the fast charging voltage) after being boosted by the booster circuit 1090. Accordingly, even when the external power supply device 420 is a normal charger, the docking device 1000 may provide the fast charging voltage to the first external electronic device 440.

According to various embodiments of the present disclosure, a electrical path can be controlled so that the electronic device may perform data communication even during fast charging.

According to various embodiments of the present disclosure, a electrical path of the fast charger can be changed after a electrical path between the electronic device and the fast charger is initially established, and thereby, it is possible to establish a electrical path which enables the electronic device to perform data communication even during fast charging.

According to various embodiments of the present disclosure, the electronic device can be controlled so as to be capable of performing data communication while fast charging is being performed, so that the convenience of the user can be improved.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which have been known or are to be developed hereinafter.

FIGS. 1-10C are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a first interface configured to connect to an external power supply device;
a second interface configured to connect to a first external electronic device; and
a control circuit operatively coupled to the first interface and the second interface, configured to:
establish a first electrical path between the first interface and the second interface, when the first interface is connected to the external power supply device and the second interface is connected to the first external electronic device;
disconnect the first electrical path; and
provide a data signal to the first external electronic device while the first external device with power that is supplied by the external power supply device, wherein the data signal and the power are provided to the first external electronic device via the second interface.

2. The electronic device as claimed in claim 1, wherein the control circuit is further configured to establish a second electrical path between the second interface and a second external electronic device for data communication.

3. The electronic device as claimed in claim 1, further comprising a third interface that is connected to a second external electronic device, wherein:
the control circuit is further configured to establish a second electrical path between the first external electronic device and the second external electronic device, and
the data signal is provided to the first external electronic device via the second electrical path.

4. The electronic device as claimed in claim 3, wherein the control circuit is configured to supply a fast charging signal to the external power supply device independently of the first external electronic device via a third electrical path.

5. The electronic device as claimed in claim 1, wherein the control circuit is configured to switch the first external electronic device from the first electrical path to a second electrical path when an identification operation is completed by at least one of the external power supply device and the first external electronic device.

6. The electronic device as claimed in claim 1, further comprising a first switch that is coupled to the second interface, wherein the control circuit is configured to control the first switch to switch the first external electronic device from the first electrical path to a second electrical path that is used for transmitting the data signal.

7. The electronic device as claimed in claim 1, further comprising a second switch that is arranged on the first electrical path, wherein the control circuit is configured to control the second switch to disconnect the first electrical path.

8. The electronic device as claimed in claim 1, further comprising a booster circuit that boosts a voltage supplied from the external power supply device, wherein the first external electronic device is fast-charged by using the booster circuit.

9. The electronic device as claimed in claim 1, wherein the external power supply device is configured to select at least one of a plurality of supported voltages, based on an identity of the first external electronic device, for provision to the first external electronic device.

10. The electronic device as claimed in claim 1, further comprising a third interface, and a hub arranged to control data communication between the first external electronic device and a second external electronic device that is connected to the first external electronic device via the third interface.

11. An electronic device comprising:
a communication interface;
a memory; and
at least one processor operatively coupled to the communication interface and the memory, configured to:
receive power from an external power supply device when the at least one processor is coupled to the external power supply device; and
receive or transmit data to an external electronic device, via the communication interface, while the at least one processor is being supplied with power by the external power supply device.

12. The electronic device as claimed in claim 11, wherein the at least one processor is configured to stop transmitting or receiving data from the external electronic device when contact with the external power supply device is detected.

13. The electronic device as claimed in claim 12, wherein the at least one processor is configured to establish a connection with the external power supply device.

14. The electronic device as claimed in claim 13, wherein the at least one processor is further configured to resume transmitting or receiving data from the external electronic device when the connection to the external power supply device is terminated.

15. The electronic device as claimed in claim 11, wherein the at least one processor is configured to stop receiving power from the external electronic device and to begin receiving power from the external power supply device, when the at least one processor is coupled to the external power supply device.

16. A method comprising:
establishing a first electrical path between an external power supply device and a first external electronic device;
disconnecting the first electrical path when an identification operation is executed by the external power supply device and the first external electronic device; and
transferring data between the first external electronic device and a second external electronic device while the first external electronic device is being supplied with power by the external power supply device.

17. The method as claimed in claim 16, further comprising establishing a second electrical path for transferring the data.

18. The method as claimed in claim 17, wherein the second electrical path spans between the first external electronic device and the second external electronic device.

19. The method as claimed in claim 16, further comprising supplying a fast charging signal to the external power supply device independently of the first external electronic device via a third electrical path that is established when the first electrical path is discoupled.
